(19) United States
(12) Patent Application Publication
(10) Pub. No.: US 2026/0370441 A1
(43) Pub. Date: Nov. 19, 2026

(54) IDLE MODE PROCEDURES FOR NARROWBAND INTERNET-OF-THINGS TIME DIVISION DUPLEX MODE CELLS

(71) Applicant: QUALCOMM Incorporated, San Diego, CA (US)

(72) Inventors: Bharat SHRESTHA, San Diego, CA (US); Alberto RICO ALVARINO, San Diego, CA (US); Umesh PHUYAL, San Diego, CA (US); Ayan SENGUPTA, Mountain View, CA (US)

(21) Appl. No.: 19/563,490

(22) Filed: Mar. 11, 2026

Related U.S. Application Data
(60) Provisional application No. 63/778,565, filed on Mar. 27, 2025.

(51) Int. Cl. H04L 5/14; H04W 36/08

(52) U.S. Cl. CPC H04L 5/14; H04W 36/08

(57) ABSTRACT

Various aspects of the present disclosure generally relate to wireless communication. In some aspects, a user equipment (UE) may determine that at least one cell is a narrowband Internet-of-things (NB-IoT) time division duplex (TDD) mode cell that is associated with a low downlink duty cycle. The UE may perform one or more idle mode procedures associated with at least one cell based at least in part on the determination that the at least one cell is the NB-IoT TDD mode cell. Numerous other aspects are described.

### CROSS-REFERENCE TO RELATED APPLICATION

This Patent Application claims priority to U.S. Provisional Patent Application No. 63/778,565, filed on Mar. 27, 2025, entitled “IDLE MODE PROCEDURES FOR NARROWBAND INTERNET-OF-THINGS TIME DIVISION DUPLEX MODE CELLS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with idle mode procedures for narrowband Internet-of-things time division duplex cells.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In some wireless communication systems, a user equipment (UE) may be a narrowband Internet-of-things (NB-IoT) UE configured to communicate with a wireless communication network via one or more NB-IoT cells. NB-IoT is a radio technology standard designed to enable a wide range of devices and services to be connected using cellular telecommunications bands. An NB-IoT UE is a device that is equipped with the necessary hardware and software to connect to an NB-IoT network. These devices are typically low-power, low-cost, and designed for applications that require long battery life and infrequent data transmissions. Examples include smart meters, environmental sensors, and various types of industrial monitoring equipment. An NB-IoT cell is a specific coverage area provided by a network node that supports NB-IoT communication. An NB-IoT cell may be optimized for low data rates, extended coverage, and massive device connectivity, making the cell suitable for IoT applications that require reliable and widespread network access.

### SUMMARY

The systems, methods, and devices of this disclosure each have several innovative aspects, no single one of which is solely responsible for the desirable attributes disclosed herein.

Some aspects described herein relate to a method of wireless communication performed by a user equipment (UE). The method may include determining that at least one cell is a narrowband Internet-of-things (NB-IoT) time division duplex (TDD) mode cell that is associated with a low downlink duty cycle. The method may include performing one or more idle mode procedures associated with the at least one cell based at least in part on the determination that the at least one cell is the NB-IoT TDD mode cell.

Some aspects described herein relate to a UE. The UE may include a processing system. The processing system may include one or more processors and one or more code-storing memories coupled with the one or more processors. The processing system may be configured to cause the UE to determine that at least one cell is an NB-IoT TDD mode cell that is associated with a low downlink duty cycle. The processing system may be configured to cause the UE to perform one or more idle mode procedures associated with the at least one cell based at least in part on the determination that the at least one cell is the NB-IoT TDD mode cell.

Some aspects described herein relate to a non-transitory computer-readable medium that stores a set of instructions for wireless communication by a UE. The set of instructions, when executed by one or more processors of the UE, may cause the UE to determine that at least one cell is an NB-IoT TDD mode cell that is associated with a low downlink duty cycle. The set of instructions, when executed by one or more processors of the UE, may cause the UE to perform one or more idle mode procedures associated with the at least one cell based at least in part on the determination that the at least one cell is the NB-IoT TDD mode cell.

Some aspects described herein relate to an apparatus for wireless communication. The apparatus may include means for determining that at least one cell is an NB-IoT TDD mode cell that is associated with a low downlink duty cycle. The apparatus may include means for performing one or more idle mode procedures associated with the at least one cell based at least in part on the determination that the at least one cell is the NB-IoT TDD mode cell.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIGS. 2A-2B are diagrams illustrating example frame structures for narrowband Internet-of-things (NB-IoT) time division duplex (TDD) communications.

FIG. 3 is a diagram of an example associated with idle mode procedures for NB-IoT TDD mode cells.

FIG. 4 is a diagram illustrating an example process performed, for example, at a user equipment (UE) or an apparatus of a UE.

FIG. 5 is a diagram of an example apparatus for wireless communication.

### DETAILED DESCRIPTION

The deployment of narrowband Internet-of-things (NB-IoT) technology in non-terrestrial networks (NTNs) (e.g., in the 1616-1626.5 MHz mobile satellite service (MSS) allocated band), presents challenges when introducing a time division duplex (TDD) pattern that is compatible with both new and legacy user equipments (UEs) (e.g., NB-IoT UEs). For example, a legacy NB-IoT UE may not support access in an MSS band when a TDD pattern is utilized (sometimes referred to herein as operating in an NB-IoT TDD mode), which may lead to difficulties in executing procedures such as cell reselection, radio resource control (RRC) reestablishments, and similar operations due to the reduced downlink subframes inherent in NB-IoT TDD mode operation. For example, the reduction in downlink signal availability may lead to changes in the periodicity of a primary synchronization signal (PSS) from 10 milliseconds (ms) in non-NB-IoT TDD mode cells (e.g., NB-IoT frequency division duplex (FDD) mode cells) to 90 ms, impacting the overall performance and reliability of communications. In this way, the introduction of a TDD pattern in the MSS band may require enhancements to idle mode mobility procedures for UEs, including procedures associated with carrier redirection, paging, cell measurements, or cell reselection priority, as well as scheduling of system information blocks (SIBs) in the NB-IoT TDD mode cell.

Moreover, any UEs that are unable to access NB-IoT TDD mode cells or that prefer not to access NB-IoT TDD mode cells due to the cells' inherently sparse downlink bandwidth may nonetheless need to acquire SIB1 for the NB-IoT TDD mode cells in order to determine band indicators or otherwise identify that the cells are NB-IoT TDD mode cells. However, due to the low downlink duty cycle of NB-IoT TDD mode cells, SIB1 may be infrequently transmitted in the NB-IoT TDD mode cells (e.g., SIB1 may be transmitted only once every 180 ms, among other examples), resulting in wasted power consumption by UEs monitoring for the infrequent SIB1 transmissions.

Various aspects relate generally to enhancing wireless communication for NB-IoT TDD mode cells (e.g., in NTNs operating in the 1616-1626.5 MHz MSS allocated band). Some aspects more specifically relate to determining that at least one cell is an NB-IoT TDD mode cell and performing one or more idle mode procedures associated with the cell based on this determination. In some aspects, a UE may deprioritize NB-IoT TDD mode cells with respect to non-NB-IoT TDD mode cells for cell reselection procedures, such as by applying a bias offset to cell reselection criteria. In some other aspects, a UE may receive one or more indications that assist in identifying a cell as an NB-IoT TDD mode cell, such as a neighboring NB-IoT TDD mode cell list transmitted by a non-NB-IoT TDD mode cell, an indication included in a master information block (MIB) transmitted by an NB-IoT TDD mode cell, or an indication of timing information of a neighboring NB-IoT TDD mode cell. In some aspects, a UE may refrain from performing certain idle mode tasks associated with an NB-IoT TDD mode cell, such as serving cell measurements during invalid downlink subframe periods characteristic of the TDD pattern, neighboring cell measurements during invalid downlink subframe periods, or similar tasks. In such aspects, the UE may maintain prior measurement results or else may reset the prior measurement results based at least in part on forgoing cell measurements during the invalid downlink subframe period, among other examples. In some aspects, a UE may identify a new (e.g., postponed) paging occasion for any paging occasions that occur during the invalid downlink subframe period.

Particular aspects of the subject matter described in this disclosure can be implemented to realize one or more of the following potential technical advantages. By tailoring idle mode procedures to an NB-IoT TDD mode cell's frame structure, the techniques described herein may conserve UE power resources otherwise associated with certain idle mode procedures, such as by reducing unnecessary signal monitoring or cell measurements in environments with low-downlink-duty cycle characteristics. In some other examples, the aspects described herein may enable conservation of UE processing resources by avoiding futile attempts to connect to or measure NB-IoT TDD mode cells. Additionally, or alternatively, some aspects enable a UE to more readily identify NB-IoT TDD mode cells, thereby conserving network resources otherwise associated with unsuccessful communication attempts or signaling overhead associated with communications between the UE and NB-IoT TDD mode cells. In some examples, aspects described herein optimize system information management by enabling receipt of an MIB indicating that a cell is an NB-IoT TDD mode cell, which enables UEs to avoid unnecessary SIB1 monitoring in incompatible cells. Moreover, some aspects described herein enable synchronization of a UE's idle mode operations with a specific timing structure of an NB-IoT TDD mode cell, resulting in a more efficient use of processing and memory resources in signal reception and processing. In this way, the aspects described herein may conserve processing resources, memory resources, network resources, or the like.

5G New Radio (NR) may support enhanced mobile broadband (eMBB) access, IoT networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, NTN deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

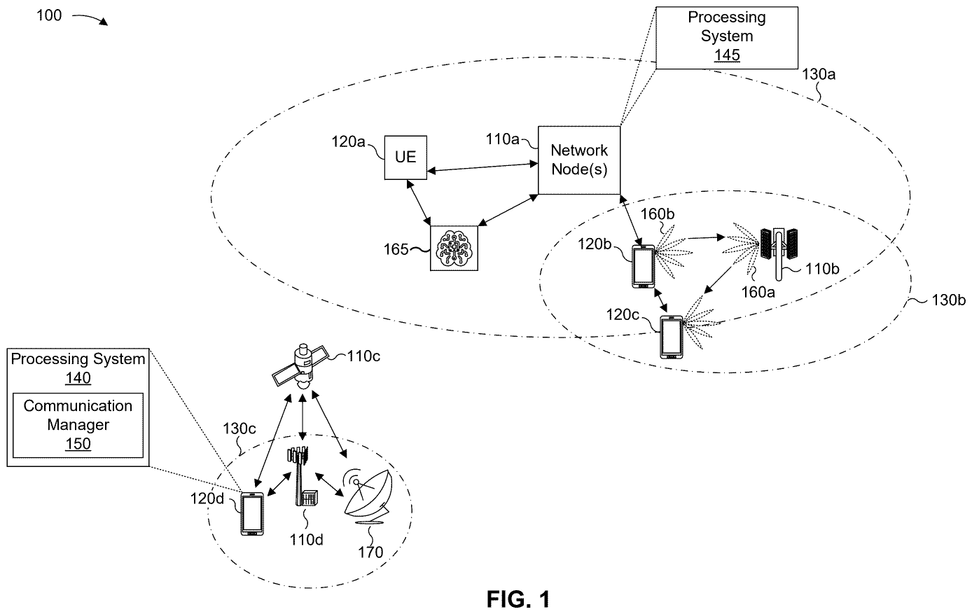

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR 1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as an RRC layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a PSS, a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

Some IoT devices, such as ambient IoT (A-IoT) devices (sometimes referred to as ultra-light IoT devices), may be associated with a relatively simple hardware design that may be designed to use low power and be implementable at low cost. A-IoT technology may include passive IoT (such as NR passive IoT for 5G Advanced), semi-passive IoT, active IoT, or ultra-light IoT. In passive IoT, a terminal (such as a tag or a similar device) may not include a battery or other long-term energy storage, and the terminal may accumulate energy from radio signaling. In some examples, the terminal may accumulate solar or other energy to supplement accumulated energy from radio signaling. To achieve further cost reduction and zero-power communication, backscattering communication may be implemented at a type of passive IoT device referred to as an “ambient backscatter device” or a “backscatter device,” which may modulate a reflecting radio signal from an RF source to convey data. Some IoT devices may be referred to as semi-passive IoT devices. At a semi-passive IoT device, communication between a reader and the IoT device does not need to be preceded by an energy harvesting waveform. For example, a semi-passive IoT device may include a battery or similar energy source that can power the semi-passive IoT device. Some IoT devices may be referred to as active IoT devices. An active IoT device may have a battery or similar energy source and an active radio, allowing for active transmission and reception without energy harvesting or backscattering. A-IoT technology may be useful in connection with industrial sensors, for which battery replacement may be prohibitively difficult or undesirable (such as for safety monitoring or fault detection in smart factories, infrastructures, or environments). Additionally, features of A-IoT devices, such as low cost, small size, simple or infrequent maintenance, durability, and long lifespan, may facilitate smart logistics and warehousing (for example, in connection with automated asset management). Furthermore, A-IoT technology may be useful in connection with smart home networks for household item management, wearable devices, or similar applications.

As indicated above, a network node 110 may be a terrestrial network node 110 (for example, a terrestrial base station or entity of a disaggregated base station) or an NTN network node 110. In the example shown in FIG. 1, the network node 110c may be an NTN node (for example, a network node 110 configured to operate in an NTN) and the cell 130c may be an NTN cell. For example, the wireless communication network 100 may include one or more NTN deployments including an NTN node or a relay station. In some examples, a relay station in an NTN deployment may be referred to as a “non-terrestrial relay station.” An NTN may facilitate access to the wireless communication network 100 for remote areas that may not otherwise be within a coverage area of a terrestrial network node 110, such as over water or remote areas in which a terrestrial network is not deployed. An NTN may provide connectivity for various applications, including satellite communications, IoT, MTC, or other applications. An NTN node may include a satellite, a manned aircraft system, or an unmanned aircraft system (UAS) platform, among other examples. A satellite may include a low-earth orbit (LEO) satellite, a medium-earth orbit (MEO) satellite, a geostationary earth orbit (GEO) satellite, or a high elliptical orbit (HEO) satellite, among other examples. A manned aircraft system may include an airplane, a helicopter, or a dirigible, among other examples. A UAS platform may include a high-altitude platform station (HAPS), a balloon, a dirigible, or an airplane, among other examples.

An NTN node (such as the network node 110c) may communicate directly or indirectly with other entities in the wireless communication network 100 using NTN communication. The other entities may include UEs 120 (for example, the UE 120d), other NTN network nodes 110 in the one or more NTN deployments, other types of network nodes 110 (for example, stationary, terrestrial, or ground-based network nodes, such as the network node 110d), relay stations, or one or more components or devices included in or coupled with a core network of the wireless communication network 100. For example, an NTN node may communicate with a UE 120 via a service link (for example, where the service link includes an access link). Additionally or alternatively, an NTN node may communicate with a gateway 170 (for example, a terrestrial node providing connectivity for the NTN node to a data network or a core network) via a feeder link (for example, where the feeder link is associated with an N2 or an N3 interface). Additionally or alternatively, NTN nodes may communicate directly with one another via an inter-satellite link (ISL). In some examples, an NTN deployment may be transparent (for example, where the NTN node operates in a similar manner as a repeater or relay or where an access link does not terminate at the NTN node). In some other examples, an NTN deployment may be regenerative. For example, an access link may terminate at the NTN node, and the NTN node may regenerate a signal (such as by performing signal processing or enhancement, which may include error correction, modulation or demodulation, or amplification).

In some examples, NTNs may support advanced technologies or capabilities, such as global narrowband IoT or mMTC coverage (for example, NTNs may provide continuous coverage for narrowband IoT devices or mMTC devices to transfer data to a central entity), enhanced tracking (for example, NTNs may enable improved tracking for a moving platform (for example, a ship, a train, a plane, or a truck) carrying specific items to be tracked), emergency or disaster management, ultra mobile broadband (ultra-mBB) (for example, NTNs may enable a UE 120 to receive or transmit large amounts of data with improve quality of experience over a wider geographic area), immersive communications (for example, NTNs may support holographic communications, or XR communications, among other examples, to enable fully immersive user experiences), ultra-massive communications (for example, NTNs may enable tracking, monitoring, control, or environment sensing for IoT devices or mMTC devices, enabling applications, such as smart cities, smart agriculture, smart transportation, or smart logistics) ultra-critical communications (for example, NTNs may support services with increased requirements for latency, availability, or reliability. This enables applications, such as tactile or haptic Internet, remote surgery, or remote industrial management) network sensing (for example, NTNs may support RF sensing or an integrated sensing and communication (ISAC) service), or integrated AI (for example, NTNs may support distributed or integrated AI applications), among other examples. In some examples, NTNs may provide connectivity for one or more verticals, such as aeronautical platforms, maritime platforms, railways, automotive platforms, rural areas, government platforms, or emergency services, among other examples.

An NTN may provide direct connectivity to the wireless communication network 100 for one or more UEs 120, such as the UE 120d. In some examples, a UE 120 may be configured to access the wireless communication network 100 via a terrestrial network (for example, the cell 130a) or an NTN (for example, the cell 130c) using common hardware or software (for example, using common radios or antennas). NTNs may provide ubiquitous connectivity for UEs 120 through compatibility with terrestrial networks (for example, NTNs and terrestrial networks may use compatible waveforms (for example, waveforms supported by both an NTN and a terrestrial network) for seamless handovers between NTNs and terrestrial networks, or UEs may use common hardware or software for communicating via NTNs and terrestrial networks), spectrum sharing (for example, a flexible waveform design may enable spectrum sharing between NTNs and terrestrial networks), robustness to co-channel interference, network-based positioning (for example, dedicated pilot signals or reference signals may be used to facilitate accurate timing and phase measurements for accurate positioning), support of UEs without location resolution data (for example, for UEs without access to a global navigation satellite system (GNSS)), or support of TDD and FDD systems, among other examples.

In some aspects, the UE 120 may include a communication manager 150. As described in more detail elsewhere herein, the communication manager 150 may determine that at least one cell is an NB-IoT TDD mode cell that is associated with a low downlink duty cycle; and perform one or more idle mode procedures associated with the at least one cell based at least in part on the determination that the at least one cell is the NB-IoT TDD mode cell. Additionally, or alternatively, the communication manager 150 may perform one or more other operations described herein.

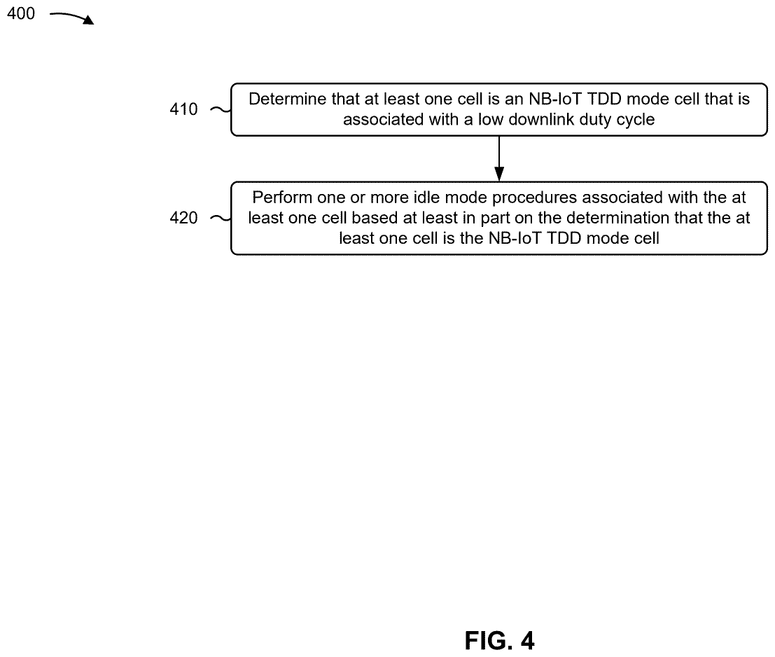

The network node 110, the processing system 145 of the network node 110, the UE 120, the processing system 140 of the UE 120, or any other component(s) of FIG. 1 may implement one or more techniques or perform one or more operations associated with idle mode procedures for NB-IoT TDD mode cells, as described in more detail elsewhere herein. For example, a processing system of the network node 110, or the processing system 140 of the UE 120 may perform or direct operations of, for example, process 400 of FIG. 4, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, the processing system 140) of the network node 110, or the UE 120, may cause the one or more processors to perform process 400 of FIG. 4, or other processes as described herein. In some examples, executing instructions may include running the instructions, converting the instructions, compiling the instructions, or interpreting the instructions, among other examples.

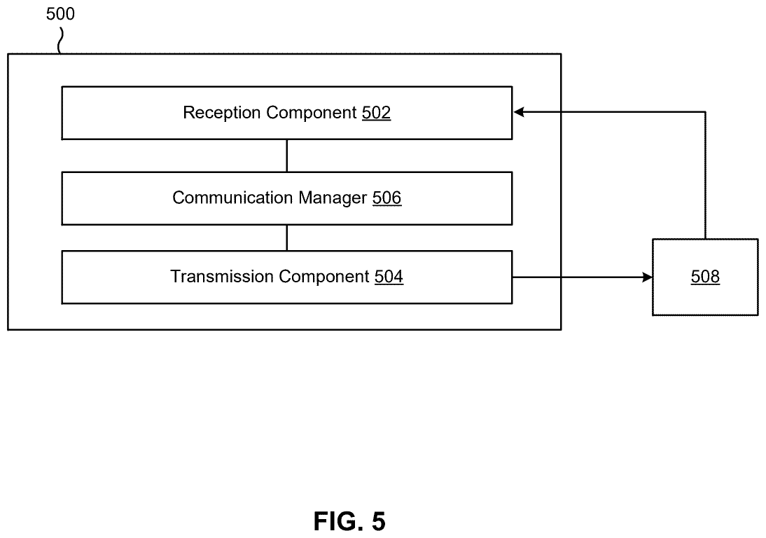

In some aspects, the UE 120 includes means for determining that at least one cell is an NB-IoT TDD mode cell that is associated with a low downlink duty cycle; or means for performing one or more idle mode procedures associated with the at least one cell based at least in part on the determination that the at least one cell is the NB-IoT TDD mode cell. In some aspects, the means for the UE 120 to perform operations described herein may include, for example, one or more of communication manager 150, processing system 140, a radio, one or more RF chains, one or more transceivers, one or more antennas, one or more modems, a reception component (for example, reception component 502 depicted and described in connection with FIG. 5), or a transmission component (for example, transmission component 504 depicted and described in connection with FIG. 5), among other examples.

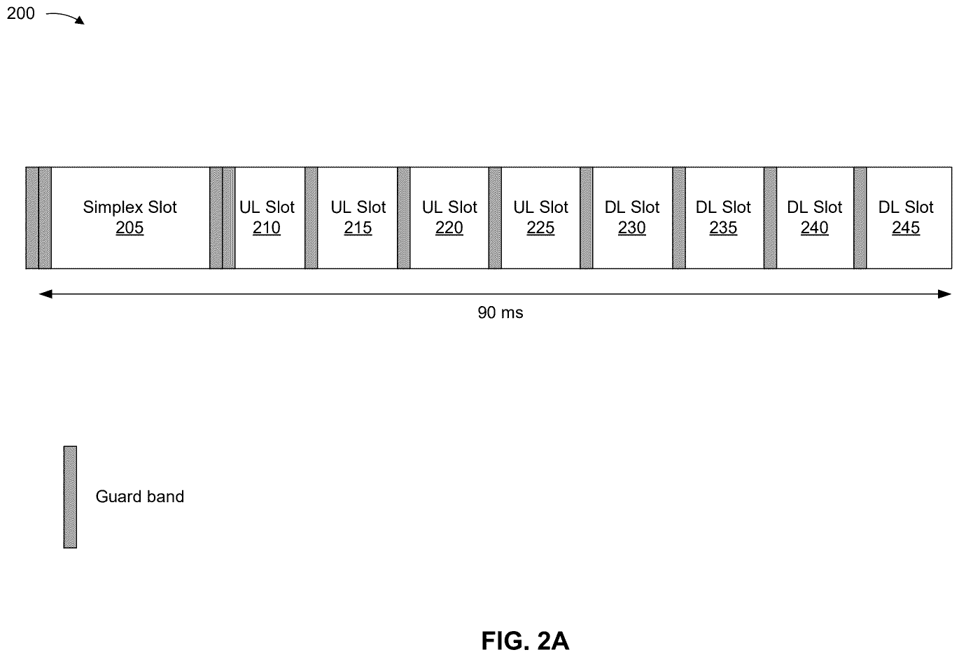

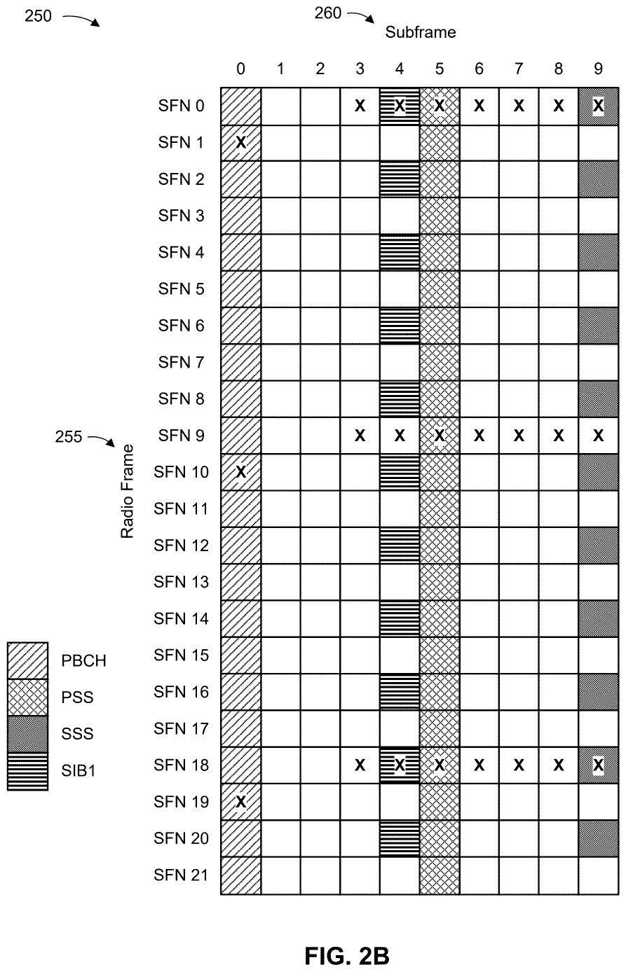

FIGS. 2A-2B are diagrams illustrating example frame structures for NB-IoT TDD communications. As shown in FIG. 2A, a frame structure 200 may be used for communications by or with an NB-IoT TDD mode cell (for example, an NB-IoT TDD mode cell operating in an MSS band, such as the 1616-1626.5 MHz MSS band). In some examples, an NB-IoT cell operating in a TDD mode enables configuring the usage of radio resources in the targeted MSS allocated band with a periodic subset of the UL and DL subframes in N radio frames. The periodic pattern may include a non-overlapping set of usable contiguous UL subframes and a set of usable contiguous DL subframes, and guard periods, which is periodic every N radio frames (with N=9 as a baseline). In such examples, no blind detection may be assumed at the UE side. In some examples, the value of N and the configuration of the periodic pattern are fixed per band.

In some examples (e.g., examples associated with the 1616-1626.5 MHz MSS band), the frame structure 200 may have periodicity of 90 ms. More particularly, as shown in FIG. 2A, the frame structure 200 may include a simplex slot 205. A simplex slot refers to a time interval assigned within a communication channel for unidirectional data transmission. In some examples, the simplex slot 205 may be used for downlink communications only, such as for ring and messaging channels. Additionally, the frame structure 200 may include a plurality of (e.g., four) uplink slots, such as UL slot 210, UL slot 215, UL slot 220, and UL slot 225. Further, the frame structure 200 may include a plurality of (e.g., four) downlink slots, such as DL slot 230, DL slot 235, DL slot 240, and DL slot 245. The frame structure 200 may additionally include a guard band between some or all of the components of the frame structure 200. In some examples, the simplex slot 205 may have a duration of 20.32 ms, each uplink slot may have a duration of 8.28 ms, and each downlink slot may have a duration of 8.28 ms. Therefore, a frame structure 200 that includes a single simplex slot, four uplink slots, and four downlink slots may have a duration of 90 ms.

In some examples, an NB-IoT TDD mode cell may be capable of communicating using all the slots of the frame structure 200 shown in FIG. 2A. However, in some other examples, an NB-IoT TDD cell may be restricted to communicating using only a subset of the slots of the frame structure 200 shown in FIG. 2A. For example, according to a predefined rule (e.g., a rule promulgated by the 3GPP, among other examples), an NB-IoT TDD mode cell operating in the 1616-1626.5 MHz MSS band may be restricted to using only eight downlink subframes of the frame structure 200 shown in FIG. 2A (sometimes referred to herein as D=8, with D corresponding the number of consecutive downlink subframes within a frame structure that are valid for downlink communication). Put another way, the NB-IoT TDD mode cell associated with D=8 may be permitted to transmit downlink communications using only one DL slot out of the four DL slots in the frame structure 200. In such examples, approximately 82 ms out of every 90 ms frame structure 200 (which corresponds to the three invalid DL slots, the four UL slots, and the simplex slot) are not permitted to be used for downlink transmissions. This 82 ms period is sometimes referred to herein as an “invalid downlink subframe period” or an “invalid downlink period,” with the 8 ms period that may be used for downlink transmissions being sometimes referred to herein as a “valid downlink subframe period” or a “valid downlink period.”

NB-IoT TDD mode cells that are limited to using only a subset of DL slots or subframes (e.g., the eight downlink subframes or one DL slot out of each 90 ms frame structure 200 in examples associated with D=8) may be said to be associated with a low downlink duty cycle (which may also be referred to as a reduced downlink duty cycle), with “low downlink duty cycle” referring to an operating mode in which less than all semi-statically configured downlink slots or subframes are permitted to be used for downlink transmissions. For example, and with reference to the example described above in connection with D=8, the low downlink duty cycle is associated with one out of the four DL slots of the frame structure 200 being a valid downlink slot (e.g., a semi-statically configured downlink slot that may be used for downlink communications) and with the other three downlink slots being invalid downlink slots (e.g., semi-statically configured downlink slots that may not be used for downlink communications). Accordingly, in examples associated with D=8, “low downlink duty cycle” refers to an operating mode in which less than ten percent of subframes are used for downlink transmissions.

This may be more readily understood with reference to FIG. 2B. FIG. 2B shows, at a subframe granularity, another frame structure 250 that may be associated with an NB-IoT cell, such as an NB-IoT mode cell that is operating using FDD. More particularly, the frame structure 250 shows a relationship between PBCH signals, PSS signals, SSS signals, and SIB1 signals that may be transmitted by an NB-IoT cell. As shown in FIG. 2B, the frame structure 250 may include multiple radio frames (as indicated by reference number 255), each associated with a corresponding system frame number (SFN) (indexed in FIG. 2B as SFN0 through SFN21). An SFN is a counter used in wireless communication systems for tracking and organizing radio frames, which provides a unique identifier for each radio frame of a communication and may be used to improve synchronization between two or more devices. Each radio frame may have a duration of 10 ms. Moreover, as indicated by reference number 260, each radio frame may be associated with ten subframes (indexed in FIG. 2B as subframes 0 through 9), each having a duration of 1 ms.

As further shown using various shading patterns in connection with the frame structure 250, the frame structure 250 may support periodic transmission of certain downlink signals, such as PBCH signals, PSS signals, SSS signals, and SIB1 signals. More particularly, PBCH transmissions may be associated with a periodicity of 10 ms (e.g., may be transmitted in subframe 0 of each radio frame), SIB1 transmissions may be associated with a periodicity of 20 ms (e.g., may be transmitted in subframe 4 of each evenly indexed radio frame), PSS transmissions may be associated with a periodicity of 10 ms (e.g., may be transmitted in subframe 5 of each radio frame), and SSS transmissions may be associated with a periodicity of 20 ms (e.g., may be transmitted in subframe 9 of each evenly indexed radio frame).

In some examples, NB-IoT TDD mode cells may be required, according to a predefined rule (e.g., a rule promulgated by the 3GPP, among other examples), to transmit PBCH signals, PSS signals, SSS signals, and SIB1 signals at the same time (e.g., in the same subframes) as the transmission of those respective signals by NB-IoT cells using the frame structure 250. In that regard, in order to ensure that a DL slot of an NB-IoT TDD mode cell associated with a low downlink duty cycle includes all essential broadcast signals (e.g., PSS, SSS, PBCH, and SIB1), a valid downlink subframe period may be configured such that valid downlink subframes or a valid downlink slot aligns with subframes [3, 4, 5, 6, 7, 8, 9, 0] (e.g., across two consecutive radio frames) once out of every 90 ms of the frame structure 250, as shown using “Xs” in FIG. 2B (e.g., subframes 3 through 9 of radio frame SFN 0 and subframe 0 of SFN 1, subframes 3 through 9 of radio frame SFN 9 and subframe 0 of SFN 10, subframes 3 through 9 of radio frame SFN 18 and subframe 0 of SFN 19, and so forth). Put another way, in examples in which a low downlink duty cycle is associated with D=8, the valid downlink subframe period may be configured to align with subframes [3, 4, 5, 6, 7, 8, 9, 0] once every 90 ms of the frame structure 250 so that all essential broadcast signals (e.g., PSS, SSS, PBCH, and SIB1) are transmitted at least once every 90 ms.

In such examples, procedures like cell reselection, RRC reestablishments, and similar procedures may be negatively impacted by the reduced downlink signals associated with the low-downlink-duty-cycle operation. For example, as shown in connection with the frame structure 250, a PSS (which has a periodicity of 10 ms in certain FDD deployments) may have a periodicity of 90 ms in low-downlink-duty-cycle deployments. Similarly, a SIB1 (which has a periodicity of 20 ms in certain FDD deployments) may have a periodicity of 180 ms in low-downlink-duty-cycle deployments. This may result in unsynchronized communications between a UE and an ND-IoT TDD cell, degraded communication channels, low throughput and high latency, or a high incidence of communication errors, resulting in high computing, power, and network resource consumption for correcting communication errors.

Some techniques and aspects described herein enable improved idle mode procedures for NB-IoT TDD mode cells, such as cells associated with a low downlink duty cycle or reduced transmission of PSS, SSS, PBCH, or SIB1 signals, among other examples. In some aspects, a UE may determine that a cell is associated with an NB-IoT TDD mode cell associated with a low downlink duty cycle, such as via a configured NB-IoT TDD mode cell neighboring list, based at least in part on a frequency band associated with the cell, or based at least in part on a new system information transmitted via a MIB, among other examples. The UE may thus perform one or more idle mode procedures associated with the cell based at least in part on the determination that the cell is an NB-IoT TDD mode cell. In some examples, such idle mode procedures may include an idle mode mobility procedure associated with the NB-IoT TDD mode cell, a carrier redirection procedure associated with the NB-IoT TDD mode cell, a paging procedure associated with the NB-IoT TDD mode cell, a measurement procedure associated with the NB-IoT TDD mode cell, a cell reselection priority procedure associated with the NB-IoT TDD mode cell, or a SIB reception procedure associated with the NB-IoT TDD mode cell, among other examples. For example, in some aspects, the UE may deprioritize the cell for mobility purposes (e.g., the NB-IoT TDD mode cell may be considered a lowest priority for cell reselection, among other examples).

In some other aspects, the UE may refrain from performing certain idle mode tasks, such as paging monitoring, serving cell measurements, neighbor cell measurements, among other examples, during an invalid downlink period. Additionally, or alternatively, in some aspects, a UE may adjust one or more paging occasions that occur during the invalid downlink period, such as by determining that the paging occasions should be moved to a valid downlink period. Moreover, a UE may identify, based at least in part on determining that a cell is an NB-IoT TDD mode cell, that certain system information (SI) is to be transmitted with a reduced periodicity as compared to FDD deployment (e.g., 90 ms, 180 ms, or the like), and may thus align UE monitoring of the SI according to the reduced periodicity or otherwise bar the NB-IoT TDD mode cell, among other examples. As a result, a UE may communicate with a network node using synchronized communications, improved communication channels, increased throughput and reduced latency, and with reduced communication errors, resulting in a reduction of computing, power, and network resource consumption otherwise needed for correcting communication errors.

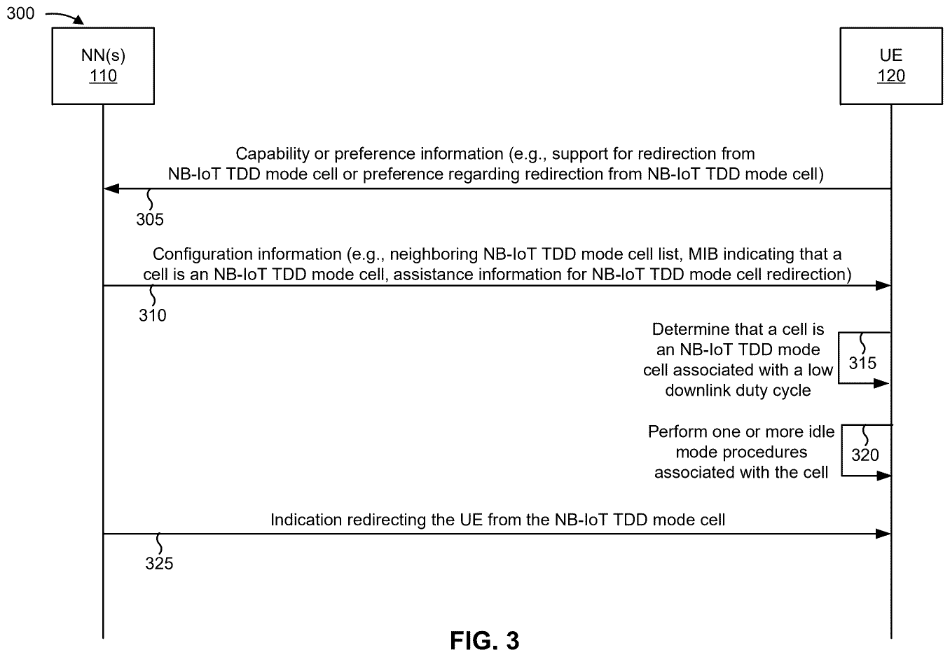

FIG. 3 is a diagram of an example 300 associated with idle mode procedures for NB-IoT TDD mode cells. As shown in FIG. 3, one or more network nodes 110 (e.g., one or more base stations, CUs, DUs, or RUs) may communicate with a UE 120. In some aspects, the one or more network nodes 110 and the UE 120 may be part of a wireless network (e.g., the wireless communication network 100). The UE 120 and at least one network node 110 may have established a wireless connection prior to operations shown in FIG. 3. In some aspects, the UE 120 may be an IoT UE or an NB-IoT UE. In some aspects, at least one network node 110 may be associated with an NB-IoT cell. For example, in some aspects, at least one network node 110 may be associated with a non-NB-IoT TDD mode cell (e.g., an NB-IoT FDD cell, among other examples), and the network node 110 may be capable of transmitting configuration information or indications associated with an NB-IoT TDD mode cell (e.g., an NB-IoT TDD mode cell associated with a low downlink duty cycle), such as a neighboring NB-IoT TDD mode cell, among other examples. Additionally, or alternatively, in some aspects, a network node 110 may be associated with an NB-IoT TDD mode cell associated with a low downlink duty cycle, and the network node 110 may transmit configuration information or one or more indications that indicate to the UE 120 that the network node 110 is associated with the NB-IoT TDD mode cell associated with the low downlink duty cycle, among other examples.

In some aspects, as shown by reference number 305, the UE 120 may transmit, and the one or more network nodes 110 may receive, capability information or preference information. The capability information or the preference information may be included in a capability report. The UE 120 may transmit the capability information or the preference information via an uplink communication, a sidelink communication, a unicast communication, a broadcast communication, a UE assistance information (UAI) communication, a UCI communication, a sidelink control information (SCI) communication, a MAC-CE communication, an RRC communication, a PUCCH, a PUSCH, a physical sidelink control channel (PSCCH), or a physical sidelink shared channel (PSSCH), among other examples. The capability information or the preference information may indicate one or more parameters associated with respective capabilities or preferences of the UE 120. The one or more parameters may be indicated via respective information elements (IEs) included in a capability report.

The capability information or the preference information may indicate whether the UE 120 supports a feature or one or more parameters related to the feature. For example, the capability information or the preference information may indicate a capability, parameter, or preference for idle mode procedures for NB-IoT TDD mode cells. As another example, the capability information or the preference information may indicate a capability, parameter, or preference for cell redirection procedures associated with NB-IoT TDD mode cells. One or more operations described herein may be based on the capability information or the preference information. For example, the UE 120 may perform a communication in accordance with the capability information or the preference information, or may receive configuration information that is in accordance with the capability information or the preference information.

In some aspects, the capability information or the preference information may indicate UE support or preference for redirection from NB-IoT TDD mode cells to non-NB-IoT TDD mode cells. Put another way, the UE 120 may indicate, via dedicated signaling to the one or more network nodes 110, whether the UE 120 supports redirection from NB-IoT TDD mode cells to non-NB-IoT TDD mode cells or the UE 120's preference for redirection (e.g., whether the UE 120 prefers NB-IoT TDD mode cells or non-NB-IoT TDD mode cells). In some aspects, the UE 120 may provide separate capability or preference indications with respect to UE support or preferences associated with redirection within NTN cells, and associated with redirection between terrestrial network (TN) and NTN cells. Put another way, the capability information may indicate UE support for redirection from NB-IoT TDD mode cells to non-NB-IoT TDD mode cells within NTN cells, separate from support for redirection from NB-IoT TDD mode cells to non-NB-IoT TDD mode cells between NTN cells and TN cells. Similarly, the preference information may indicate preferences associated with redirection from NB-IoT TDD mode cells to non-NB-IoT TDD mode cells within NTN cells, separate from preferences associated with redirection from NB-IoT TDD mode cells to non-NB-IoT TDD mode cells between NTN cells and TN cells.

As shown by reference number 310, the one or more network nodes 110 may transmit, and the UE 120 may receive, configuration information. In some aspects, the UE 120 may receive the configuration information via one or more of system information signaling (e.g., an MIB or a SIB, among other examples), RRC signaling, MAC signaling (e.g., one or more MAC-CEs), or physical layer signaling (e.g., DCI), among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may select a candidate configuration or communication parameter from the one or more candidate configurations or communication parameters. In some aspects, the subsequent indication may include a dynamic indication, such as one or more MAC-CEs or one or more DCI messages, among other examples.

In some aspects, the configuration information may include an indication of a selection of one or more configuration parameters (e.g., a selection of the one or more configuration parameters already known to the UE 120 or previously indicated by the network node or other network device), or explicit configuration information for the UE 120 to use to configure the UE 120, among other examples.

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some aspects, the configuration information may indicate that at least one cell associated with the UE 120 is an NB-IoT TDD mode cell associated with a low downlink duty cycle. More particularly, in aspects in which the configuration information is received from a network node 110 associated with a non-NB-IoT TDD mode cell, the network node 110 may indicate whether a neighbor cell is an NB-IoT TDD mode cell or not. In some aspects, a network node 110 may do so by providing the UE 120 with a neighboring NB-IoT TDD mode cell list that indicates nearby NB-IoT TDD mode cells. That is, a wireless communication standard (e.g., a wireless communication standard promulgated by the 3GPP) may define a list of neighbor cells to be signaled by the network node 110 to the UE 120 that indicates which neighboring cells are NB-IoT TDD mode cells.

In some other aspects, such as in aspects in which the configuration information is received from a network node 110 associated with an NB-IoT TDD mode cell, the network node 110 may indicate, via the configuration information, that it is an NB-IoT TDD mode cell. For example, the configuration information may be transmitted via a MIB that includes an indication that the cell is an NB-IoT TDD mode cell, among other examples. More particularly, in some aspects, certain UEs may not support NB-IoT TDD mode cells or may otherwise be unable to connect to NB-IoT TDD mode cells, while certain other UEs may wish to avoid NB-IoT TDD mode cells due to the reduced downlink duty cycle or for similar purposes (as described above in connection with FIG. 2B). However, due to the long periodicity associated with SIB1 in such cells (e.g., 180 ms in some examples), those UEs may consume much time and power resources to monitor for and acquire the SIB1 , only to then determine, via the information provided in SIB1, that the cell is an NB-IoT TDD mode cell and thus is to be avoided.

Accordingly, in some aspects, the MIB may include an indication that the cell is an NB-IoT TDD mode cell. In such aspects, UEs that are unable to connect to NB-IoT TDD mode cells or UEs that wish to avoid NB-IoT TDD mode cells may leave the cell after acquiring and reading the MIB, thereby conserving the power and time resources otherwise consumed to monitor and receive SIB1. In some aspects, the indication that the cell is an NB-IoT TDD mode cell may be associated with a scheduling information parameter (sometimes referred to herein as schedulingInfoSIB1 or schedulingInfoSIB1-r19). The schedulingInfoSIB1 parameter refers to a scheduling IE provided in the MIB that provides details about the scheduling of SIB1. In some aspects, a schedulingInfoSIB1 may indicate a codepoint of 0-11 to indicate a corresponding number of narrowband PDCCH (NPDCCH) repetitions, with a value of 12, 13, 14, or 15 being reserved.

In such aspects, a schedulingInfoSIB 1 value of 12, 13, 14, or 15 may be used to indicate to the UE 120 that the cell is an NB-IoT TDD mode cell. For example, a UE that is not capable of connecting to an NB-IoT TDD mode cell may be OEM programmed or otherwise preconfigured to associate a schedulingInfoSIB1 value of 12, 13, 14, or 15 as a reserved value. In such aspects, upon acquiring the MIB and reading a schedulingInfoSIB1 value of 12, 13, 14, or 15, the UE may not be able to determine a TB size (TBS) for the cell, SIB1 repetitions for the cell, a starting SFN for the SIB1 of the cell, or other information associated with the SIB1.

Accordingly, the UE may be unable to read the SIB1 and thus may leave the cell after reading the MIB (e.g., the schedulingInfoSIB1 value of 12, 13, 14, or 15 may be an implicit indication that the cell is not a cell type to which the UE can connect or that the cell is an NB-IoT TDD mode cell). On the other hand, a UE that is capable of connecting to an NB-IoT TDD mode cell may be OEM programmed or otherwise preconfigured to associate a schedulingInfoSIB1 value of 12, 13, 14, or 15 with an NB-IoT TDD mode cell. Accordingly, if the UE does not wish to connect to NB-IoT TDD mode cells, the UE may leave the cell after reading the MIB (e.g., the schedulingInfoSIB1 value of 12, 13, 14, or 15 may be an explicit indication that the cell is an NB-IoT TDD mode cell in this example). Additionally, or alternatively, a new type of scheduling information IE for a MIB may be defined (sometimes referred to herein as schedulingInfoSIB1-new), which may be used for an NB-IoT TDD mode cell supported only in standalone mode, among other examples, that explicitly indicates to any UEs capable of reading the schedulingInfoSIB1-new parameter that the cell is an NB-IoT TDD mode cell.

In some other aspects, an “access barring enabled” parameter (sometimes referred to herein as ab-enabled) may be used to indicate whether a cell is an NB-IoT TDD mode cell. An access barring parameter may be used by a network node to control network congestion by temporarily preventing certain UEs from accessing the network. That is, when ab-enabled is set to true, the cell may bar some access requests based on predefined rules, among other examples. Accordingly, in some aspects, a network node 110 may use an access barring parameter (e.g., ab-enabled) to implicitly indicate that a certain cell is an NB-IoT TDD mode cell or to otherwise prevent certain UEs from accessing the cell. For example, an access barring enabled parameter associated with a certain release of a wireless communication standard (such as release 13 (R13) of a wireless communication standard promulgated by the 3GPP, sometimes referred to herein as ab-enabler-r13) may be used to implicitly indicate to UEs that may not be capable of connecting to an NB-IoT TDD mode cell that the cell is an NB-IoT TDD mode cell. Additionally, or alternatively, an access barring enabled parameter associated with a different release of a wireless communication standard (such as release 19 (R19) of a wireless communication standard promulgated by the 3GPP, sometimes referred to herein as ab-enabler-r19) may be used to implicitly indicate to UEs that may be capable of connecting to an NB-IoT TDD mode cell that the cell is an NB-IoT TDD mode cell or that the UE should nonetheless refrain from connecting to the cell. In some aspects, an access barring enabled parameter (e.g., ab-enabled-r19) may be signaled using a spare bit in the MIB.

Additionally, or alternatively, in some aspects, a network node 110 may indicate timing information of a neighboring NB-IoT TDD mode cell. The timing information may be an offset of SFN 0 of the neighboring NB-IoT TDD mode cell with respect to the SFN 0 of the current serving cell. For neighbor cell measurements, the UE 120 may use the neighboring NB-IoT TDD mode cell's timing information to detect the neighboring NB-IoT TDD mode cell's invalid downlink subframe period and thus to identify that the UE 120 does not need to perform measurements during the invalid downlink subframe period, which is described in more detail below in connection with reference number 320. Similar operations may be useful when the current serving cell is a normal mode NB-IoT cell.

In some aspects, the configuration information indicated by reference number 310 may indicate assistance information associated with connecting to or switching from one or more NB-IoT TDD mode cells. For example, the configuration information may indicate assistance information associated with a redirection of the UE 120 between NB-IoT TDD mode cells and non-NB-IoT TDD mode cells, which is described in more detail below in connection with reference number 325. In such aspects, the assistance information may include information such as a cell identifier (ID) associated with an NB-IoT TDD mode cell, ephemeris information of a satellite associated with the NB-IoT TDD mode cell, or similar information. Put another way, in some aspects a network node 110 may signal, to the UE, assistance information that indicates one of one or more cell IDs or satellite location information associated with one or more cells, among other information.

As described in more detail below in connection with reference number 320, in some aspects the UE 120 may determine new paging occasions (POs) for an NB-IoT TDD mode cell, such as when a configured PO falls during an invalid downlink period (e.g., during the 82 ms of the TDD frame structure during which no downlink communications are to take place, as described above in connection with FIG. 2B, among other examples). In such aspects, the configuration information may indicate one or more parameters to be used by the UE 120 for determining the new POs. For example, the configuration information may indicate a quantity (e.g., X) of valid downlink subframe periods to monitor for POs. In such aspects, when a PO occurs during an invalid downlink subframe period, the UE 120 may monitor for paging communications in the next X valid downlink subframe periods (which is described in more detail below in connection with reference number 320).

The UE 120 may configure itself based at least in part on the configuration information. In some aspects, the UE 120 may be configured to perform one or more operations described herein based at least in part on the configuration information.

As indicated by reference number 315, the UE 120 may determine that at least one cell (e.g., at least one serving cell or at least one neighboring cell) is an NB-IoT TDD mode cell. For example, as described above in connection with reference number 310, in some aspects the UE 120 may receive an indication that a cell is an NB-IoT TDD mode cell (e.g., via a neighboring NB-IoT TDD mode cell list; a schedulingInfoSIB1 parameter, a schedulingInfoSIB1-new parameter, an ab-enabled parameter, or a similar parameter in a MIB; or a similar indicator). In such aspects, determining that the at least one cell is an NB-IoT TDD mode cell is based at least in part on the indication that the at least one cell is an NB-IoT TDD mode cell. In some other aspects, the UE 120 may determine that at least one cell is an NB-IoT TDD mode cell based at least in part on a frequency band associated with the at least one cell. Put another way, the UE 120 may determine that a certain cell is an NB-IoT TDD mode cell based at least in part on a list of frequency bands that are associated with NB-IoT TDD mode cells (e.g., such as the 1616-1626.5 MHz MSS allocated band, among other examples).

As indicated by reference number 320, the UE 120 may perform one or more idle mode procedures associated with the at least one cell based at least in part on the determination that the at least one cell is the NB-IoT TDD mode cell. For example, the UE 120 may perform one or more idle mode mobility procedures, carrier redirection procedures, paging monitoring and reception procedures, cell measurement procedures, cell reselection priority procedures, SIB monitoring procedures, or similar procedures, based at least in part on the determination that the at least one cell is the NB-IoT TDD mode cell.

In some aspects, performing the one or more idle mode procedures associated with the at least one NB-IoT TDD mode cell includes performing a cell reselection procedure that includes deprioritizing the at least one NB-IoT TDD mode cell with respect to at least one non-NB-IoT TDD mode cell. Put another way, the UE 120 may consider an NB-IoT TDD mode cell of lowest priority for cell reselection. In some aspects, deprioritizing the at least one NB-IoT TDD mode cell with respect to the at least one non-NB-IoT TDD mode cell includes applying a bias offset to cell reselection criteria associated with the at least one NB-IoT TDD mode cell. That is, the UE 120 may deprioritize NB-IoT TDD mode cells by implementing a bias offset for ranking-based cell reselection criteria. In some other aspects, deprioritizing the at least one NB-IoT TDD mode cell with respect to the at least one non-NB-IoT TDD mode cell is based at least in part on a predefined rule (e.g., a rule defined by 3GPP or OEM programmed at the UE 120) indicating that non-NB-IoT TDD mode cells are to be prioritized over NB-IoT TDD mode cells. Put another way, deprioritizing NB-IoT TDD mode cells may be achieved by specifying a new NB-IoT UE behavior on cell reselection prioritization to be lower for NB-IoT TDD mode cells. In some other aspects, such as aspects in which the UE 120 is provided with an indication of whether a neighbor cell is an NB-IoT TDD mode cell (e.g., in aspects in which the configuration information includes the neighboring NB-IoT TDD mode cell list), neighbor cell measurements of NB-IoT TDD mode cells may be given a lowest priority, among other examples.

In some aspects, such as aspects in which the UE 120 supports cell redirection between NB-IoT TDD mode cells and non-NB-IoT TDD mode cells, performing the one or more idle mode procedures associated with the NB-IoT TDD mode cell includes performing a cell redirection procedure between the NB-IoT TDD mode cell and a non-NB-IoT TDD mode cell. For example, as indicated by reference number 325, based at least in part on the capability information, the preference information, or the assistance information described above in connection with reference number 305, a network node 110 may transmit, and the UE 120 may receive, an indication redirecting the UE 120 from the at least one NB-IoT TDD mode cell to a non-NB-IoT TDD mode cell. In such aspects, performing the one or more idle mode procedures includes connecting to the non-NB-IoT TDD mode cell based at least in part on receiving the indication redirecting the UE 120 from the at least one NB-IoT TDD mode cell to the non-NB-IoT TDD mode cell.

As described above in connection with FIG. 2B, in some aspects an NB-IoT TDD mode cell may be associated with a low downlink duty cycle TDD pattern that includes an invalid downlink subframe period (e.g., 82 ms out of every 90 ms, among other examples). In such aspects, performing the one or more idle mode procedures may include the UE 120 refraining from performing one or more idle mode tasks associated with the at least one NB-IoT TDD mode cell during the invalid downlink subframe period. Put another way, during the invalid downlink subframe period (e.g., 82 ms out of 90 ms), a wireless communication standard (e.g., a standard promulgated by the 3GPP) may define that the UE 120 is not required to perform certain idle mode tasks, such as paging monitoring, serving cell measurements, logged measurement procedures, neighbor cell measurements, or similar idle mode tasks.

More particularly, in some aspects, the UE 120 may refrain from performing serving cell measurements during the invalid downlink subframe period. In such aspects, if the UE 120's regular serving cell measurement occasion occurs during the invalid downlink subframe period, the UE 120 may postpone the serving cell measurements until a valid downlink subframe period (e.g., the next valid SFN, such as an SFN associated with subframes indicated by “X” in FIG. 2B). Additionally, or alternatively, the UE 120 may either maintain one or more previous serving cell measurement results based at least in part on refraining from performing the one or more idle mode tasks, or else may reset the one or more previous serving cell measurement results based at least in part on refraining from performing the one or more idle mode tasks. Put another way, in some aspects, any layer 3 (L3) filter for serving cell measurements or previous samples of serving cell measurements may not be reset or otherwise updated during the invalid downlink subframe period, and, in some other aspects, serving cell measurement samples may be reset during the invalid downlink subframe period (and thus the UE 120 may start over with serving cell measurements at the next valid downlink SFN). In some aspects, the UE 120 behavior during the invalid downlink subframe period may be applicable to an RRC connected state (sometimes referred to as an RRC_CONNECTED state).

Additionally, or alternatively, if the UE 120's regular serving cell measurement occasion occurs during the invalid downlink subframe period, the UE 120 may maintain at least one of a current “serving cell received level” parameter (sometimes referred to herein as an Srxlev parameter) or a reference serving cell received level parameter (e.g., a reference Srxlev parameter) during the invalid downlink subframe period, or may pause a cell reselection timer (sometimes referred to herein as Treselection) during the invalid downlink subframe period. Put another way, for relaxed serving cell measurements (e.g., for aspects in which a serving cell measurement occasion that occurs during an invalid downlink subframe period is postponed until a valid downlink subframe period), the current Srxlev value of the serving cell (e.g., in decibels (dB)) and reference Srxlev value of the serving cell (e.g., dB) may not be reset and may be kept unchanged during the invalid downlink subframe period. Additionally, or alternatively, the UE 120 may utilize relaxed monitoring criteria (sometimes referred to as TSearchDeltaP), or the cell reselection time criteria or timer (e.g., Treselection) may be paused during the invalid downlink subframe period.

In some aspects, performing the one or more idle mode procedures associated with at least one NB-IoT TDD mode cell may include the UE 120 refraining from performing neighbor cell measurements during the invalid downlink subframe period. In such aspects, the UE 120 may reset one or more neighbor cell measurement results associated with the at least one NB-IoT TDD mode cell prior to a start of the valid downlink subframe period. Put another way, based at least in part on a neighbor cell measurement occasion falling during the invalid downlink subframe period, the UE 120 may reset or delete neighbor cell measurement samples used for cell reselection or cell selection before the start of the next valid downlink subframe period. In such aspects, the UE 120 may still perform regular neighbor cell measurement tasks including normal NTN cells and TN cells based on existing rules (e.g., location or time), among other examples.

Moreover, in aspects in which the UE 120 refrains from performing cell measurements during the invalid downlink subframe period, the UE 120 may store a cell type indicator or a band indicator with one or more cell measurement results, such as for a purpose of indicating that the cell measurements are not up to date or otherwise were not performed during an invalid downlink subframe period. Put another way, logged measurement results or a self-organizing network (SON)/minimization of drive tests (MDT) report may include an indication of an NB-IoT TDD mode cell type or band indicator associated with the measurements.

In some aspects, performing the one or more idle mode procedures may include the UE 120 determining that one or more POs that occur during the invalid downlink subframe period are invalid. In such aspects, the UE 120 may identify one or more new POs that occur during a valid downlink subframe period to be used in place of the one or more POs that occur during the invalid downlink subframe period. For example, in aspects in which the UE 120 receives configuration information indicating a quantity of valid downlink subframe periods to monitor for POs (e.g., X, as described above in connection with reference number 310), the UE 120 may identify the one or more new POs by identifying a quantity of new POs that correspond to the quantity of valid downlink subframe periods to monitor for POs (e.g., X).

Put another way, a PO falling in the invalid downlink subframe period may be considered invalid by the UE 120. In some aspects, an offset to the PO may be defined (e.g., via a relevant wireless communication standard, such as a standard promulgated by the 3GPP) to move the PO to a valid downlink subframe period to reduce a paging delay. Additionally, or alternatively, paging repetitions or POs completely or partially overlapping with the invalid downlink subframe period or SI messages may be continued in the next valid downlink subframe period.

In some aspects, any paging repetitions falling in a next PO (or exceeding a next PO) will be dropped. For example, if an NB interval (e.g., a time duration allocated for NB transmissions) is equal to 1/64^{th} of a reference time interval, T (e.g., NB=T/64), then there may be a 64-subframe gap between two consecutive POs. In such examples, any paging repetition that crosses into the next PO (e.g., that is to be moved more than 64 subframes) may be dropped. Put another way, from a starting subframe of a given PO occurring during an invalid downlink subframe period, if a quantity of postponed paging subframes is greater than a quantity of non-downlink subframes plus a quantity of configured paging repetitions minus 64, then some of the paging repetitions may be dropped so that paging repetitions may begin for a new PO. In this way, a network node 110 may configure (e.g., via the configuration information described in connection with reference number 310) a value of a quantity of NB intervals between two POs or such that the paging repetitions will not cross over the next PO.

In some aspects, paging repetitions associated with a given PO may be postponed to multiple valid downlink subframe periods. For example, a quantity of paging repetitions may be greater than eight (thus requiring more than eight downlink subframes), and thus multiple valid downlink subframe periods may be needed for the UE 120 to fully receive all paging repetitions for a given PO. Additionally, or alternatively, due to SI message scheduling or resource unavailability, among other examples, a certain PO may need to be postponed multiple valid downlink subframe periods. In that regard, when a PO is to be moved to a valid downlink subframe period, the UE may need to monitor multiple valid downlink subframe periods for the moved paging signaling. For example, as described above in connection with reference number 310, in some aspects a network node 110 may configure the UE 120 with a quantity of valid downlink subframe periods to monitor for paging (e.g., X), and the start of the moved paging repetitions may take place in any of the indicated valid downlink subframe periods. For example, when X=2, the UE 120 may monitor the next two valid downlink subframe periods to receive the paging signaling (e.g., the paging NPDCCH), and the paging may be transmitted by the network node 110 in either of the next two valid downlink subframe periods.

As described above in connection with reference number 310, in some aspects the configuration information may be received, by the UE 120, from an NB-IoT TDD mode cell or may be associated with an MIB that includes an indication that the at least one cell is the NB-IoT TDD mode cell (e.g., the schedulingInfoSIB1 indication, the schedulingInfoSIB1-new indication, or the ab-enabled indication, among other examples). In such aspects, performing the one or more idle mode procedures may include refraining from monitoring for a SIB1 in the at least one NB-IoT TDD mode cell based at least in part on receiving the indication in the MIB, as described above.

Additionally, or alternatively, in some aspects, performing the one or more idle mode procedures includes monitoring for SI in the at least one NB-IoT TDD mode cell based at least in part on using at least one of an SI periodicity that is aligned to NB-IoT TDD mode cells, an SI window length that is aligned to NB-IoT TDD mode cells, or an SI modification period that is aligned to NB-IoT TDD mode cells. More particularly, as described above in connection with FIG. 2B, due to the low downlink duty cycle of an NB-IoT TDD mode cell or otherwise (e.g., because only 82 ms out of 90 ms may be used for downlink transmissions), a periodicity of an SI may be 180 ms using traditional SI configurations. In order to provide more frequent SI transmissions, a new scheduling of SI may be defined (e.g., by a relevant wireless communication standard, such as a wireless communication promulgated by the 3GPP) such that an SI periodicity is aligned with the 90 ms periodicity associated with NB-IoT TDD mode cells, such that an SI window length is aligned with the 90 ms periodicity associated with NB-IoT TDD mode cells, or such that a paging cycle aligns with the 90 ms periodicity associated with NB-IoT TDD mode cells to ensure that the SI modification period is aligned with the 90 ms periodicity. In such aspects, although a paging cycle may remain unchanged from traditional configurations, an SI modification boundary may be moved to a next valid DL subframe period.

Based at least in part on the UE 120 performing one or more idle mode procedures in light of determining that at least one cell is an NB-IoT TDD mode cell, the UE 120 or the one or more network nodes 110 may conserve computing, power, network, or communication resources that may have otherwise been consumed by traditional idle mode procedures. For example, based at least in part on the UE 120 performing one or more idle mode procedures in light of determining that at least one cell is an NB-IoT TDD mode cell, the UE 120 may conserve computing, power, network, or communication resources that may have otherwise been consumed detecting, measuring, connecting to, or otherwise communicating with NB-IoT TDD mode cells.

As indicated above, FIG. 3 is provided as an example. Other examples may differ from what is described with respect to FIG. 3.

FIG. 4 is a diagram illustrating an example process 400 performed, for example, at a UE or an apparatus of a UE. Example process 400 is an example where the apparatus or the UE (e.g., UE 120) performs operations associated with idle mode procedures for NB-IoT TDD mode cells.

As shown in FIG. 4, in some aspects, process 400 may include determining that at least one cell is an NB-IoT TDD mode cell that is associated with a low downlink duty cycle (block 410). For example, the UE (e.g., using communication manager 506, depicted in FIG. 5) may determine that at least one cell is an NB-IoT TDD mode cell that is associated with a low downlink duty cycle, as described above.

As further shown in FIG. 4, in some aspects, process 400 may include performing one or more idle mode procedures associated with the at least one cell based at least in part on the determination that the at least one cell is the NB-IoT TDD mode cell (block 420). For example, the UE (e.g., using communication manager 506, depicted in FIG. 5) may perform one or more idle mode procedures associated with the at least one cell based at least in part on the determination that the at least one cell is the NB-IoT TDD mode cell, as described above.

Process 400 may include additional aspects, such as any single aspect or any combination of aspects described below or in connection with one or more other processes described elsewhere herein.

In a first aspect, performing the one or more idle mode procedures associated with the at least one cell includes performing a cell reselection procedure that includes deprioritizing the at least one cell with respect to at least one non-NB-IoT TDD mode cell.

In a second aspect, alone or in combination with the first aspect, deprioritizing the at least one cell with respect to the at least one non-NB-IoT TDD mode cell includes applying a bias offset to cell reselection criteria associated with the at least one cell.

In a third aspect, alone or in combination with one or more of the first and second aspects, deprioritizing the at least one cell with respect to the at least one non-NB-IoT TDD mode cell is based at least in part on a predefined rule indicating that non-NB-IoT TDD mode cells are to be prioritized over NB-IoT TDD mode cells.

In a fourth aspect, alone or in combination with one or more of the first through third aspects, process 400 includes receiving an indication that the at least one cell is an NB-IoT TDD mode cell, wherein determining that at least one cell is the NB-IoT TDD mode cell is based at least in part on the indication.

In a fifth aspect, alone or in combination with one or more of the first through fourth aspects, the indication is associated with a neighboring NB-IoT TDD mode cell list.

In a sixth aspect, alone or in combination with one or more of the first through fifth aspects, the indication further indicates timing information of the NB-IoT TDD mode cell.

In a seventh aspect, alone or in combination with one or more of the first through sixth aspects, the timing information indicates a timing offset of a subframe of the NB-IoT TDD mode cell with respect to a subframe of a serving cell.

In an eighth aspect, alone or in combination with one or more of the first through seventh aspects, determining that at least one cell is the NB-IoT TDD mode cell is based at least in part on a frequency band associated with the at least one cell.

In a ninth aspect, alone or in combination with one or more of the first through eighth aspects, process 400 includes receiving an indication redirecting the UE from the at least one cell to a non-NB-IoT TDD mode cell, wherein performing the one or more idle mode procedures includes connecting to the non-NB-IoT TDD mode cell based at least in part on receiving the indication.

In a tenth aspect, alone or in combination with one or more of the first through ninth aspects, process 400 includes transmitting at least one of capability information indicating support for redirection from NB-IoT TDD mode cells to non-NB-IoT TDD mode cells, or preference information indicating preferences associated with redirection from NB-IoT TDD mode cells to non-NB-IoT TDD mode cells.

In an eleventh aspect, alone or in combination with one or more of the first through tenth aspects, at least one of the capability information indicates support for redirection from NB-IoT TDD mode cells to non-NB-IoT TDD mode cells within NTN cells separate from support for redirection from NB-IoT TDD mode cells to non-NB-IoT TDD mode cells between NTN cells and TN cells, or the preference information indicates preferences associated with redirection from NB-IoT TDD mode cells to non-NB-IoT TDD mode cells within NTN cells separate from preferences associated with redirection from NB-IoT TDD mode cells to non-NB-IoT TDD mode cells between NTN cells and TN cells.

In a twelfth aspect, alone or in combination with one or more of the first through eleventh aspects, process 400 includes receiving assistance information associated with the redirection from NB-IoT TDD mode cells to non-NB-IoT TDD mode cells, wherein the assistance information indicates at least one of one or more cell identifiers, or satelliting location information associated with one or more cells.

In a thirteenth aspect, alone or in combination with one or more of the first through twelfth aspects, the low downlink duty cycle is associated with a TDD pattern that includes an invalid downlink subframe period, and the process 400 further includes refraining from performing one or more idle mode tasks associated with the at least one cell during the invalid downlink subframe period.

In a fourteenth aspect, alone or in combination with one or more of the first through thirteenth aspects, the one or more idle mode tasks are associated with serving cell measurements, and process 400 includes one of maintaining one or more previous serving cell measurement results based at least in part on refraining from performing the one or more idle mode tasks, or resetting the one or more previous serving cell measurement results based at least in part on refraining from performing the one or more idle mode tasks.

In a fifteenth aspect, alone or in combination with one or more of the first through fourteenth aspects, the one or more idle mode tasks are associated with serving cell measurements, and process 400 includes at least one of maintaining at least one of a current serving cell received level parameter or a reference serving cell received level parameter during the invalid downlink subframe period, or pausing a cell reselection timer during the invalid downlink subframe period.

In a sixteenth aspect, alone or in combination with one or more of the first through fifteenth aspects, the one or more idle mode tasks are associated with neighbor cell measurements, and process 400 includes resetting one or more neighbor cell measurement results associated with the one or more cells prior to a start of a valid downlink subframe period.

In a seventeenth aspect, alone or in combination with one or more of the first through sixteenth aspects, the one or more idle mode tasks are associated with cell measurements, and process 400 includes storing at least one of a cell type indicator or a band indicator with one or more cell measurement results.

In an eighteenth aspect, alone or in combination with one or more of the first through seventeenth aspects, the at least one cell is associated with a TDD pattern that includes an invalid downlink subframe period, and performing the one or more idle mode procedures includes determining that one or more POs that occur during the invalid downlink subframe period are invalid.

In a nineteenth aspect, alone or in combination with one or more of the first through eighteenth aspects, performing the one or more idle mode procedures includes identifying one or more new POs that occur during a valid downlink subframe period to be used in place of the one or more POs that occur during the invalid downlink subframe period.

In a twentieth aspect, alone or in combination with one or more of the first through nineteenth aspects, process 400 includes receiving configuration information indicating a quantity of valid downlink subframes to monitor for POs, wherein identifying the one or more new POs includes identifying a quantity of new POs that correspond to the quantity of valid downlink subframes to monitor for POs.

In a twenty-first aspect, alone or in combination with one or more of the first through twentieth aspects, process 400 includes receiving a master information block that includes an indication that the at least one cell is the NB-IoT TDD mode cell, wherein performing the one or more idle mode procedures includes refraining from monitoring for a system information block 1 in the at least one cell based at least in part on receiving the indication.

In a twenty-second aspect, alone or in combination with one or more of the first through twenty-first aspects, process 400 includes receiving a master information block that includes new scheduling information for monitoring a system information block associated with the at least one cell.

In a twenty-third aspect, alone or in combination with one or more of the first through twenty-second aspects, performing the one or more idle mode procedures includes monitoring for SI in the at least one cell based at least in part on using at least one of an SI periodicity that is aligned to NB-IoT TDD mode cells, an SI window length that is aligned to NB-IoT TDD mode cells, or an SI modification period that is aligned to NB-IoT TDD mode cells.

Although FIG. 4 shows example blocks of process 400, in some aspects, process 400 may include additional blocks, fewer blocks, different blocks, or differently arranged blocks than those depicted in FIG. 4. Additionally, or alternatively, two or more of the blocks of process 400 may be performed in parallel.

FIG. 5 is a diagram of an example apparatus 500 for wireless communication. The apparatus 500 may be a UE, or a UE may include the apparatus 500. In some aspects, the apparatus 500 includes a reception component 502, a transmission component 504, or a communication manager 506, which may be in communication with one another (for example, via one or more buses or one or more other components). In some aspects, the communication manager 506 is the communication manager 150 described in connection with FIG. 1. As shown, the apparatus 500 may communicate with another apparatus 508, such as a UE or a network node (such as a CU, a DU, an RU, or a base station), using the reception component 502 and the transmission component 504. The communication manager 506 may be included in, or implemented via, a processing system (for example, the processing system 140 described in connection with FIG. 1) of the UE.

In some aspects, the apparatus 500 may be configured to perform one or more operations described herein in connection with FIG. 3. Additionally, or alternatively, the apparatus 500 may be configured to perform one or more processes described herein, such as process 400 of FIG. 4. In some aspects, the apparatus 500 or one or more components shown in FIG. 5 may include one or more components of the UE described in connection with FIG. 1. Additionally, or alternatively, one or more components shown in FIG. 5 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 502 may receive communications, such as reference signals, control information, data communications, or a combination thereof, from the apparatus 508. The reception component 502 may provide received communications to one or more other components of the apparatus 500. In some aspects, the reception component 502 may perform signal processing on the received communications, and may provide the processed signals to the one or more other components of the apparatus 500. In some aspects, the reception component 502 may include one or more components of the UE described above in connection with FIG. 1, such as a radio, one or more RF chains, one or more transceivers, or one or more modems, each of which may in turn be coupled with one or more antennas of the UE.

The transmission component 504 may transmit communications, such as reference signals, control information, data communications, or a combination thereof, to the apparatus 508. In some aspects, one or more other components of the apparatus 500 may generate communications and may provide the generated communications to the transmission component 504 for transmission to the apparatus 508. In some aspects, the transmission component 504 may perform signal processing on the generated communications, and may transmit the processed signals to the apparatus 508. In some aspects, the transmission component 504 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 504 may be co-located with the reception component 502.

The communication manager 506 may support operations of the reception component 502 or the transmission component 504. For example, the communication manager 506 may receive information associated with configuring reception of communications by the reception component 502 or transmission of communications by the transmission component 504. Additionally, or alternatively, the communication manager 506 may generate or provide control information to the reception component 502 or the transmission component 504 to control reception or transmission of communications.

The communication manager 506 may determine that at least one cell is an NB-IoT TDD mode cell that is associated with a low downlink duty cycle. The communication manager 506 may perform one or more idle mode procedures associated with the at least one cell based at least in part on the determination that the at least one cell is the NB-IoT TDD mode cell.

The reception component 502 may receive an indication that the at least one cell is an NB-IoT TDD mode cell, wherein determining that at least one cell is the NB-IoT TDD mode cell is based at least in part on the indication.

The reception component 502 may receive an indication redirecting the UE from the at least one cell to a non-NB-IoT TDD mode cell, wherein performing the one or more idle mode procedures includes connecting to the non-NB-IoT TDD mode cell based at least in part on receiving the indication.

The transmission component 504 may transmit at least one of capability information indicating support for redirection from NB-IoT TDD mode cells to non-NB-IoT TDD mode cells, or preference information indicating preferences associated with redirection from NB-IoT TDD mode cells to non-NB-IoT TDD mode cells.

The reception component 502 may receive assistance information associated with the redirection from NB-IoT TDD mode cells to non-NB-IoT TDD mode cells wherein the assistance information indicates at least one of: one or more cell identifiers, or satellite location information associated with one or more cells.

The reception component 502 may receive configuration information indicating a quantity of valid downlink subframes to monitor for POs, wherein identifying the one or more new POs includes identifying a quantity of new POs that correspond to the quantity of valid downlink subframes to monitor for POs.

The reception component 502 may receive a master information block that includes an indication that the at least one cell is the NB-IoT TDD mode cell, wherein performing the one or more idle mode procedures includes refraining from monitoring for a system information block 1 in the at least one cell based at least in part on receiving the indication.

The reception component 502 may receive a master information block that includes new scheduling information for monitoring a system information block associated with the at least one cell.

The number and arrangement of components shown in FIG. 5 are provided as an example. In practice, there may be additional components, fewer components, different components, or differently arranged components than those shown in FIG. 5. Furthermore, two or more components shown in FIG. 5 may be implemented within a single component, or a single component shown in FIG. 5 may be implemented as multiple, distributed components. Additionally, or alternatively, a set of (one or more) components shown in FIG. 5 may perform one or more functions described as being performed by another set of components shown in FIG. 5.

The following provides an overview of some Aspects of the present disclosure:
Aspect 1: A method of wireless communication performed by a user equipment (UE), comprising: determining that at least one cell is a narrowband Internet-of-things (NB-IoT) time division duplex (TDD) mode cell that is associated with a low downlink duty cycle; and performing one or more idle mode procedures associated with the at least one cell based at least in part on the determination that the at least one cell is the NB-IoT TDD mode cell.
Aspect 2: The method of Aspect 1, wherein performing the one or more idle mode procedures associated with the at least one cell includes performing a cell reselection procedure that includes deprioritizing the at least one cell with respect to at least one non-NB-IoT TDD mode cell.
Aspect 3: The method of Aspect 2, wherein deprioritizing the at least one cell with respect to the at least one non-NB-IoT TDD mode cell includes applying a bias offset to cell reselection criteria associated with the at least one cell.
Aspect 4: The method of Aspect 2, wherein deprioritizing the at least one cell with respect to the at least one non-NB-IoT TDD mode cell is based at least in part on a predefined rule indicating that non-NB-IoT TDD mode cells are to be prioritized over NB-IoT TDD mode cells.
Aspect 5: The method of any of Aspects 1-4, further comprising receiving an indication that the at least one cell is an NB-IoT TDD mode cell, wherein determining that at least one cell is the NB-IoT TDD mode cell is based at least in part on the indication.
Aspect 6: The method of Aspect 5, wherein the indication is associated with a neighboring NB-IoT TDD mode cell list.
Aspect 7: The method of Aspect 5, wherein the indication further indicates timing information of the NB-IoT TDD mode cell.
Aspect 8: The method of Aspect 7, wherein the timing information indicates a timing offset of a subframe of the NB-IoT TDD mode cell with respect to a subframe of a serving cell.
Aspect 9: The method of any of Aspects 1-8, wherein determining that at least one cell is the NB-IoT TDD mode cell is based at least in part on a frequency band associated with the at least one cell.
Aspect 10: The method of any of Aspects 1-9, further comprising receiving an indication redirecting the UE from the at least one cell to a non-NB-IoT TDD mode cell, wherein performing the one or more idle mode procedures includes connecting to the non-NB-IoT TDD mode cell based at least in part on receiving the indication.
Aspect 11: The method of Aspect 10, further comprising transmitting at least one of: capability information indicating support for redirection from NB-IoT TDD mode cells to non-NB-IoT TDD mode cells, or preference information indicating preferences associated with redirection from NB-IoT TDD mode cells to non-NB-IoT TDD mode cells.
Aspect 12: The method of Aspect 11, wherein at least one of: the capability information indicates support for redirection from NB-IoT TDD mode cells to non-NB-IoT TDD mode cells within non-terrestrial network (NTN) cells separate from support for redirection from NB-IoT TDD mode cells to non-NB-IoT TDD mode cells between NTN cells and terrestrial network (TN) cells, or the preference information indicates preferences associated with redirection from NB-IoT TDD mode cells to non-NB-IoT TDD mode cells within NTN cells separate from preferences associated with redirection from NB-IoT TDD mode cells to non-NB-IoT TDD mode cells between NTN cells and TN cells.
Aspect 13: The method of Aspect 10, further comprising receiving assistance information associated with the redirection from NB-IoT TDD mode cells to non-NB-IoT TDD mode cells, wherein the assistance information indicates at least one of: one or more cell identifiers, or satellite location information associated with one or more cells.
Aspect 14: The method of any of Aspects 1-13, wherein the low downlink duty cycle is associated with a TDD pattern that includes an invalid downlink subframe period, and wherein the method further comprises refraining from performing one or more idle mode tasks associated with the at least one cell during the invalid downlink subframe period.
Aspect 15: The method of Aspect 14, wherein the one or more idle mode tasks are associated with serving cell measurements, and wherein the method further comprises one of: maintaining one or more previous serving cell measurement results based at least in part on refraining from performing the one or more idle mode tasks, or resetting the one or more previous serving cell measurement results based at least in part on refraining from performing the one or more idle mode tasks.
Aspect 16: The method of Aspect 14, wherein the one or more idle mode tasks are associated with serving cell measurements, and wherein the method further comprises at least one of: maintaining at least one of a current serving cell received level parameter or a reference serving cell received level parameter during the invalid downlink subframe period, or pausing a cell reselection timer during the invalid downlink subframe period.
Aspect 17: The method of Aspect 14, wherein the one or more idle mode tasks are associated with neighbor cell measurements, and wherein the method further comprises resetting one or more neighbor cell measurement results associated with the one or more cells prior to a start of a valid downlink subframe period.
Aspect 18: The method of Aspect 14, wherein the one or more idle mode tasks are associated with cell measurements, and wherein the method further comprises storing at least one of a cell type indicator or a band indicator with one or more cell measurement results.
Aspect 19: The method of any of Aspects 1-18, wherein the at least one cell is associated with a TDD pattern that includes an invalid downlink subframe period, and wherein performing the one or more idle mode procedures includes determining that one or more paging occasions (POs) that occur during the invalid downlink subframe period are invalid.
Aspect 20: The method of Aspect 19, wherein performing the one or more idle mode procedures includes identifying one or more new POs that occur during a valid downlink subframe period to be used in place of the one or more POs that occur during the invalid downlink subframe period.
Aspect 21: The method of Aspect 20, further comprising receiving configuration information indicating a quantity of valid downlink subframes to monitor for POs, and wherein identifying the one or more new POs includes identifying a quantity of new POs that correspond to the quantity of valid downlink subframes to monitor for POs.
Aspect 22: The method of any of Aspects 1-21, further comprising receiving a master information block that includes an indication that the at least one cell is the NB-IoT TDD mode cell, and wherein performing the one or more idle mode procedures includes refraining from monitoring for a system information block 1 in the at least one cell based at least in part on receiving the indication.
Aspect 23: The method of any of Aspects 1-22, further comprising receiving a master information block that includes new scheduling information for monitoring a system information block associated with the at least one cell.
Aspect 24: The method of any of Aspects 1-23, wherein performing the one or more idle mode procedures includes monitoring for system information (SI) in the at least one cell based at least in part on using at least one of: an SI periodicity that is aligned to NB-IoT TDD mode cells, an SI window length that is aligned to NB-IoT TDD mode cells, or an SI modification period that is aligned to NB-IoT TDD mode cells.
Aspect 25: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-24.
Aspect 26: An apparatus for wireless communication at a device, the apparatus comprising one or more memories and one or more processors coupled to the one or more memories, the one or more processors configured to cause the device to perform the method of one or more of Aspects 1-24.
Aspect 27: An apparatus for wireless communication, the apparatus comprising at least one means for performing the method of one or more of Aspects 1-24.
Aspect 28: A non-transitory computer-readable medium storing code for wireless communication, the code comprising instructions executable by one or more processors to perform the method of one or more of Aspects 1-24.
Aspect 29: A non-transitory computer-readable medium storing a set of instructions for wireless communication, the set of instructions comprising one or more instructions that, when executed by one or more processors of a device, cause the device to perform the method of one or more of Aspects 1-24.
Aspect 30: A device for wireless communication, the device comprising a processing system that includes one or more processors and one or more memories coupled with the one or more processors, the processing system configured to cause the device to perform the method of one or more of Aspects 1-24.
Aspect 31: An apparatus for wireless communication at a device, the apparatus comprising one or more memories and one or more processors coupled to the one or more memories, the one or more processors individually or collectively configured to cause the device to perform the method of one or more of Aspects 1-24.
Aspect 32: A device comprising a processing system that includes one or more processors and one or more code-storing memories coupled with the one or more processors, the processing system configured to cause the device to perform the method of one or more of Aspects 1-24.
Aspect 33: A device comprising a processing system that includes processor circuitry and code-storing memory circuitry, the processing system configured to cause the device to perform the method of one or more of Aspects 1-24.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
determine that at least one cell is a narrowband Internet-of-things (NB-IoT) time division duplex (TDD) mode cell that is associated with a low downlink duty cycle; and
perform one or more idle mode procedures associated with the at least one cell based at least in part on the determination that the at least one cell is the NB-IoT TDD mode cell.

2. The UE of claim 1, wherein the processing system, to cause the UE to perform the one or more idle mode procedures associated with the at least one cell, is configured to cause the UE to perform a cell reselection procedure that includes deprioritizing the at least one cell with respect to at least one non-NB-IoT TDD mode cell.

3. The UE of claim 2, wherein the processing system, to cause the UE to deprioritize the at least one cell with respect to the at least one non-NB-IoT TDD mode cell, is configured to cause the UE to apply a bias offset to cell reselection criteria associated with the at least one cell.

4. The UE of claim 2, wherein the processing system, to cause the UE to deprioritize the at least one cell with respect to the at least one non-NB-IoT TDD mode cell, is configured to cause the UE to deprioritize the at least one cell with respect to the at least one non-NB-IoT TDD mode cell based at least in part on a predefined rule indicating that non-NB-IoT TDD mode cells are to be prioritized over NB-IoT TDD mode cells.

5. The UE of claim 1, wherein the processing system is configured to cause the UE to receive an indication that the at least one cell is an NB-IoT TDD mode cell, and wherein the processing system, to cause the UE to determine that the at least one cell is the NB-IoT TDD mode cell, is configured to cause the UE to determine that the at least one cell is the NB-IoT TDD mode cell based at least in part on the indication.

6. The UE of claim 5, wherein the indication is associated with a neighboring NB-IoT TDD mode cell list.

7. The UE of claim 5, wherein the indication further indicates timing information of the NB-IoT TDD mode cell.

8. The UE of claim 7, wherein the timing information indicates a timing offset of a subframe of the NB-IoT TDD mode cell with respect to a subframe of a serving cell.

9. The UE of claim 1, wherein the processing system, to cause the UE to determine that the at least one cell is the NB-IoT TDD mode cell, is configured to cause the UE to determine that the at least one cell is the NB-IoT TDD mode cell based at least in part on a frequency band associated with the at least one cell.

10. The UE of claim 1, wherein the processing system is configured to cause the UE to receive an indication redirecting the UE from the at least one cell to a non-NB-IoT TDD mode cell, and
wherein the processing system, to cause the UE to perform the one or more idle mode procedures, is configured to cause the UE to connect to the non-NB-IoT TDD mode cell based at least in part on receiving the indication.

11. The UE of claim 10, wherein the processing system is configured to cause the UE to transmit at least one of:
capability information indicating support for redirection from NB-IoT TDD mode cells to non-NB-IoT TDD mode cells, or
preference information indicating preferences associated with redirection from NB-IoT TDD mode cells to non-NB-IoT TDD mode cells.

12. The UE of claim 11, wherein at least one of:
the capability information indicates support for redirection from NB-IoT TDD mode cells to non-NB-IoT TDD mode cells within non-terrestrial network (NTN) cells separate from support for redirection from NB-IoT TDD mode cells to non-NB-IoT TDD mode cells between NTN cells and terrestrial network (TN) cells, or
the preference information indicates preferences associated with redirection from NB-IoT TDD mode cells to non-NB-IoT TDD mode cells within NTN cells separate from preferences associated with redirection from NB-IoT TDD mode cells to non-NB-IoT TDD mode cells between NTN cells and TN cells.

13. A method of wireless communication performed by a user equipment (UE), comprising:
determining that at least one cell is a narrowband Internet-of-things (NB-IoT) time division duplex (TDD) mode cell that is associated with a low downlink duty cycle; and
performing one or more idle mode procedures associated with the at least one cell based at least in part on the determination that the at least one cell is the NB-IoT TDD mode cell.

14. The method of claim 13, wherein performing the one or more idle mode procedures associated with the at least one cell includes performing a cell reselection procedure that includes deprioritizing the at least one cell with respect to at least one non-NB-IoT TDD mode cell.

15. The method of claim 14, wherein deprioritizing the at least one cell with respect to the at least one non-NB-IoT TDD mode cell includes applying a bias offset to cell reselection criteria associated with the at least one cell.

16. The method of claim 14, wherein deprioritizing the at least one cell with respect to the at least one non-NB-IoT TDD mode cell is based at least in part on a predefined rule indicating that non-NB-IoT TDD mode cells are to be prioritized over NB-IoT TDD mode cells.

17. The method of claim 13, further comprising receiving an indication that the at least one cell is an NB-IoT TDD mode cell,
wherein determining that at least one cell is the NB-IoT TDD mode cell is based at least in part on the indication.

18. The method of claim 17, wherein the indication further indicates timing information of the NB-IoT TDD mode cell.

19. The method of claim 18, wherein the timing information indicates a timing offset of a subframe of the NB-IoT TDD mode cell with respect to a subframe of a serving cell.

20. A non-transitory computer-readable medium storing a set of instructions for wireless communication, the set of instructions comprising:
one or more instructions that, when executed by one or more processors of a user equipment, cause the user equipment to:
determine that at least one cell is a narrowband Internet-of-things (NB-IoT) time division duplex (TDD) mode cell that is associated with a low downlink duty cycle; and
perform one or more idle mode procedures associated with at least one cell based at least in part on the determination that the at least one cell is the NB-IoT TDD mode cell.
